(19) United States
(12) Patent Application Publication
(10) Pub. No.: US 2024/0316867 A1
(43) Pub. Date: Sep. 26, 2024

(54) CUSTOM THREE-DIMENSIONAL PRINTING OF OBJECTS

(71) Applicants: Parthasarathy GOPAL, San Diego, CA (US); Karkuzhali KUNCHITHAPATHAM, San Diego, CA (US)

(72) Inventors: Parthasarathy GOPAL, San Diego, CA (US); Karkuzhali KUNCHITHAPATHAM, San Diego, CA (US)

(21) Appl. No.: 18/615,136

(22) Filed: Mar. 25, 2024

Related U.S. Application Data
(60) Provisional application No. 63/492,126, filed on Mar. 24, 2023.

(51) Int. Cl. B29C 64/379; B29C 64/386; B33Y 10/00; B33Y 30/00; B33Y 40/20; B33Y 50/00

(52) U.S. Cl. CPC B29C 64/379; B29C 64/386; B33Y 10/00; B33Y 30/00; B33Y 40/20; B33Y 50/00

(57) ABSTRACT

A method of manufacturing a custom object includes generating a three-dimensional (3D) object using a 3D printer, operating an alignment mechanism to position the object in a customization area; and generating a target custom object by applying customization to the object in the customization area. The customization may be applied using an ultraviolet printer.

### CROSS REFERENCE TO RELATED APPLICATIONS

This patent document claims benefit of priority to U.S. Provisional Application No. 63/492, 126, filed on Mar. 24, 2023. The entire content of the before-mentioned patent application is incorporated by reference as part of the disclosure of this application.

### TECHNICAL FIELD

The present document relates to three-dimensional (3D) printing technology area.

### BACKGROUND

Three-dimensional printing technology holds the promise of fabricating three-dimensional objects. Over the years, developments in the 3D printing technology have led to fabrication of more and more complex objects.

### SUMMARY

This document discloses techniques that allow for 3D printing of customized objects.

In one example aspect, method is disclosed. The method includes manufacturing a custom object by generating a three-dimensional (3D) object using a 3D printer; operating an alignment mechanism to position the object in a customization area; and generating a target custom object by applying customization to the object in the customization area.

In another example aspect, another method is disclosed. The method includes receiving, from a user interface, a custom pattern; and operating an ultra-violet (UV) printer to print the custom pattern on an output of a three-dimensional (3D) printer, wherein the output of the 3D printer is aligned with the UV printer according to a rule.

In another example aspect, a computer platform comprising a processor is disclosed. The processor is configured to implement an above-recited method.

In yet another example aspect, the method may be embodied as processor-executable code and may be stored on a computer-readable program medium.

These, and other, features are described in this document.

### DESCRIPTION OF THE DRAWINGS

FIG. 1 shows an example of a 3D printing system.

FIGS. 2 and 3 are flowcharts for various example methods of custom 3D printing.

FIG. 4 shows a hardware platform for implementing some techniques described in the present document.

FIG. 5 shows a flowchart of an example method of custom 3D printing of objects.

FIG. 6 shows a flowchart for an example method of custom 3D printing of objects.

FIG. 7 shows an example alignment mechanism that facilitates custom 3D printing.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document to improve readability of the description and do not in any way limit the discussion or the embodiments to the respective sections only.

### 1. Introduction—3D Printing

Engineering advances in 3D printing technologies in the recent years has made it possible to print 3D objects that can be used in real-life situations. Increased robustness of printing technology and reduced price points has made it possible to print objects in a cost-effective manner. Objects with simple geometries can be printed using consumer-grade 3D printers that have become accessible through retail and online sellers. However, 3D printing technology remains complicated to use. For example, most users find that calibration and setting up a 3D printer to accurately print objects is tedious. Furthermore, unlike conventional printers that print on paper, most users to no need to print anything in 3D on a daily basis. Therefore, mass-scale adoption of 3D printing technology has not yet happened, despite the availability of relatively low priced, portable 3D printers.

The present document provides, among other solutions, technical solutions that will unlock the true potential of 3D printing technology buy allowing users to access 3D printing without having to spend time and money in acquiring 3D printers and get trained about how to operate and maintain them. In one example aspect, 3D printers may be placed in publicly accessible locations in kiosks and may be operated using a local user interface (UI) or through remove control such as a web-based app to allow users to print 3D objects and customize these objects with designs or photographs provided by the users. In another example aspect, the disclosed technology allows remote set up, maintenance and control of the 3D printer. The quality and accuracy of the customization feature is facilitated by a precise coordination between 3D objects printed from a 3D printer and a labeler that applied customization to the 3D objects.

These, and other, aspects are described throughout the present document.

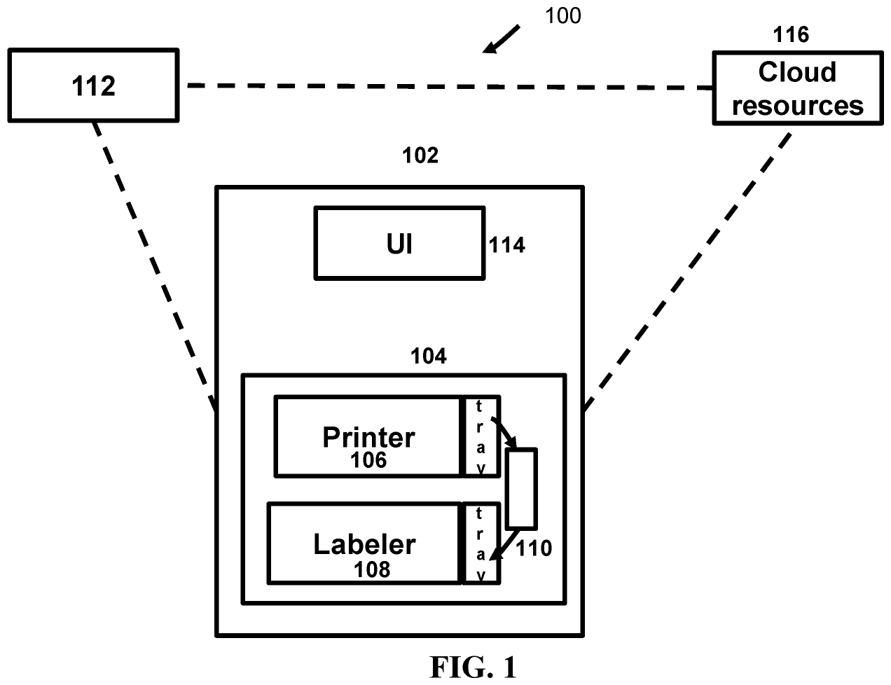

FIG. 1 shows and example of a 3D printing system 100. In this example, a kiosk 102 is equipped with a printing system 104, which includes a printer 106 and a labeler 108. An alignment mechanism 110 is configured to operate between the printer 106 and the labeler 108. In some embodiments, a user interface (UI) 114 may be provided at the kiosk 102. In some embodiments, the kiosk 102 may operate by communicating with a user device 112 and other computing resources 116 such as cloud computing resources, as further described in the present document.

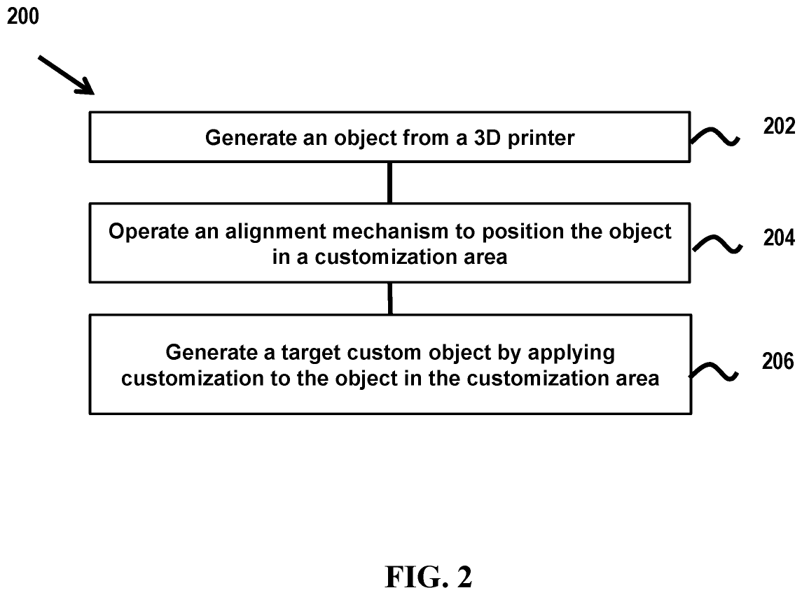

In some embodiments, a workflow 200 performed using the 3D printing system 100 may be as follows. Ad depicted in FIG. 2, at 202, an object may be generated from the 3D printer. For example, the 3D printer may be controlled under command of a computer located in the kiosk 102 (not explicitly shown in FIG. 1 and or the user device 112 and/or another computer from the computing resources 116. For example, the object may be generated by printing from the printer 106 and placed in a tray (not explicitly shown) attached to the printer 106.

At 204, the alignment mechanism 110 may be operated to position the object into a customization area associated with the labeler 108. The alignment mechanism 110 may provide the correct alignment to ensure that the labeler 108 is able to imprint a user-desired pattern precisely on one or more locations of the object generated by the printer 106.

At 206, the labeler 108 may apply the customization to the object positioned in the customization area and generate a target custom object. For example, the target custom object may comprise a user specified design or some other information printed on the object.

### 2. Example—Custom 3D Printing

In some embodiments, the custom 3D printing may comprise three operations—first is printing of a generic 3D object such as a phone case for a particular phone model or a coaster for placing hot items, or decorative items and so on. The second operation may involve preparing the generic 3D object printed by the 3D printer for the next (third) operation of customization. In various embodiments, the preparation may include one or more of—performing verification that the generic 3D has been successfully printed, detecting an orientation/position of the 3D object, and moving or rotating the 3D object into a position that facilitates customization.

In some embodiments, the verification is performed based on user feedback, e.g., through UI 104. A user may be prompted to confirm that the desired object has been printed correctly. In some embodiments, the verification may be performed in an automated manner. For example, a weight sensor may determine weight of the printed object and verify that the weight is within the expected weight range. As another example, a touch sensor may ensure that it is able to detect that the object is touching the placement area or output tray of the 3D printer. In some embodiments, a visual sensor may be used to perform visual analysis of the printed object and compare with a template to ensure that the object is correctly printed. An image of the object may be captured and stored for tasks such as auditing, trouble-shooting or other tasks.

In some embodiments the orientation/position of the object may be detected based on a sensor array on the output tray of the 3D printer that detects size and shape of the object after it is printed in the output tray. In some cases, the detected shape of the object may not provide information about orientation of the object. For example, an object printed with a circular pedestal may be detected in the output tray, but its orientation may not be determinable simply from the circular footprint. To assist with orientation detection, various embodiments may use one or more of the following techniques. In one example, orientation information may be added to the bottom surface of the object—such as texture changes not perceptible by humans but detectable by machine, or printed information such as a line or an arrow pointing to the forward direction or one or more visual markers on the surface of the object that allows a determination of the orientation of the object.

A similar check on the orientation and location of placement of the object may be made when the object is moved from the output tray of the 3D printer to the input tray of the labeler 108 that performs customization.

In case that the placement/orientation of the 3D object is not correct or does not match a desired position/orientation, the alignment mechanism 110 may be provided an indication and/or a control signal to operate to move the printed object into the correct position/orientation. The operations of sensing position/orientation and correcting the position/orientation may be iteratively performed until the printed object is finally in a correct position/orientation. In some embodiments, the object itself may be moved relative to the surface on which the object is resting. In some embodiments, in addition or alternatively, the surface may be moved relative to the object, e.g., the input tray of the labeler may be rotated or shifted.

After the current location of the printed 3D object is ascertained to be correct, custom 3D printing may be performed on the object. The custom 3D printing may apply a user-specified image or embossing or etching pattern the printed object. For example, the labeler may be a color printer equipped with multiple colors and may use a user-defined stencil to apply the ink to the object. Alternatively, or in addition, the labeler 108 may also etch or emboss texture or other 3D patterns on the object. In some embodiments, during the custom 3D printing, the object may be moved or rotated according to the stencil. In some embodiments, the print heads of the labeler 108 may be moved to apply the stencil to the object. In some embodiments both the object and the printhead of the labeler 108 ma move during the custom 3D printing.

### 3. Examples of 3D Printers

Currently, several 3D printers are available in market that may be adapted to implement the various techniques described in the present document. For example, commercially available printers such as Delta wasp 2040 Pro may be used. A typical 3D printer is sensitive to the temperature of operation, which includes the temperature at which the 3D ink is kept and/or the temperature at which the printing mechanism (e.g., nozzle) operates. Accordingly, a preferred 3D printer may have a relatively broad operational temperature range (e.g., nominal temperature plus-minus 5 degrees Fahrenheit). As further disclosed in the present document, an external mechanism such as air circulation-based cooling or heating, direct electrical heating coils, etc., may be used to ensure isothermic operation of 3D printers.

### 4. Examples of Customization Printers

Currently, several 3D printers are available in market that may be adapted to implement the various techniques described in the present document. For example, commercially available printers such as Roland VersaUV LEF 12i may be used. In general, a printer that is able to be configured to accept a pattern and present on surface of an object that is different from paper may be used as a customization printer.

### 5. Examples of Alignment Mechanisms

In some embodiments, the alignment mechanism 110 may be a robotic arm. The robotic arm may be configured to grasp a printed 3D object from the output tray of the printer 106 and move to the input tray of the labeler 108. In some embodiments, the alignment mechanism may be assisted by some invisible or barely noticeable printer cues such as a specific geometric signature printed in an embedded manner on the 3D printed object. The alignment mechanism may seek and grasp the printed 3D object with help of the printed cue and comparing the printed cue with an a priori cue pattern that the alignment mechanism is aware of. For example, the robotic arm may be configured with an image recognition mechanism (a camera and a processor configured to analyze images captured by the camera) that aligns the robotic arm for grasping the printed object, lifting the printed object and moving the printed object to the input tray of the labeler.

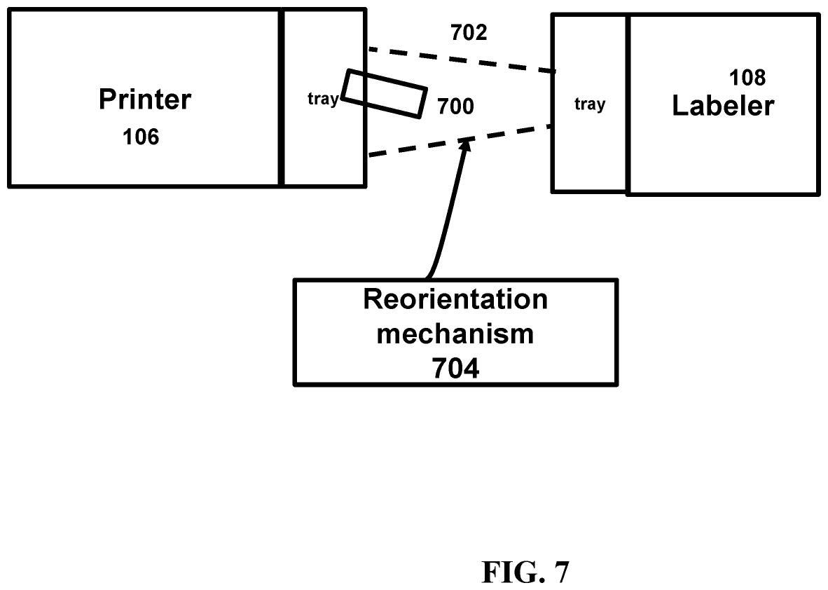

In some embodiments, e.g., as depicted in FIG. 7, the alignment mechanism may use a tapered tray 702 that includes a funnel-shaped chute which allows objects (e.g., object 700) to enter the broader opening of the chute with any orientation and then progressively aligns the object in a correct orientation while the object is moved through the funnel towards the tapering exit from where the object is able to exit the chute and be placed into the input tray of the labeler only at a certain orientation. As an example, when a phone case is printed, the chute opening is adjusted such that the phone case may only exit the chute with the smaller dimension (typically width of the phone case) aligned with the tapering exit. An alignment mechanism may include a reorientation mechanism 704 such as a motorized subsystem that exerts a mechanical forces which shakes or wiggles the tapered chute to cause the printed object to constantly be re-oriented to have a correct orientation. The labeler and the input tray of the labeler may collectively be called the customization area. Here, customization may include an image or a pattern of a user's liking, as is further described in the present document.

Although the example embodiment depicted in FIG. 7 shows movement of the printed object 700 occurring from left to right, in various embodiments, the object may be moved along a planer tapering chute that is also inclined and benefits from gravity such that the object 700 naturally slides downwards from the tray of the printer 106 to the tray of the labeler 108 while the tapering chute 702 is continuously wiggled to orient the object correctly. A sensor placed at the input tray of the labeler 108 may provide feedback to the reorientation mechanism 704 once the object 700 is correctly situated within the tray.

### 6. Examples of Kiosk Configurations

Previously described FIG. 1 shows an example of a kiosk configuration. In some embodiments, the kiosk may be a secure facility that provides access to the printing system 104 upon validation of access authorization. For example, a user may be able to interact with the computing resources 116 to obtain an authorization that allows access to the printing system 104. The authorization may be, e.g., a barcode, a QR code or an alphanumeric password that can be used to access the printing system 104. In some embodiments, the access authorization provided to the user may also carry information about what the user can print using the printing system 104 and/or a time window of authorization.

### 7. Examples of Custom Pattern Uploading

In some embodiments, the custom patterns or stencils used by users to achieve customization of the printed objects may be uploaded prior to the actual printing time using the user device 112 and interacting with the computing resources 116. For example, the user may be able to upload an image or an instruction file that specifies graphics and/or lettering from the user device 112 to the computing resources 116. The computing resources 116 may in turn perform a verification that the customization desired by a user can be printed using a specific kiosk location where the user wants to print the custom object. The computing device 112 may download the custom pattern received from the user to the printing system 104. The computing resources 116 may perform a handshake with the printing system 104 to verify that the downloaded custom pattern can be printed by the printing system 104.

In some embodiments, the custom pattern includes an image format such as graphics interchange format (GIF), JPEG, PNG or the like. In some embodiments, the custom pattern may include a graphic file. In some embodiments, the custom pattern may include depth or 3D information. In some embodiments, the customization pattern may be based on a number of templates that the user may be able to browse through and select from. The customization templates may be organized according to themes or other user-specifiable types.

In some embodiments, a user may be able to walk to the kiosk and use the printing facility while being at the location. In such a use case, the user may be able to upload the desired custom pattern to the printing system 104 either via a network connection or by directly inserting a card or memory device into the printing system 104 at kiosk.

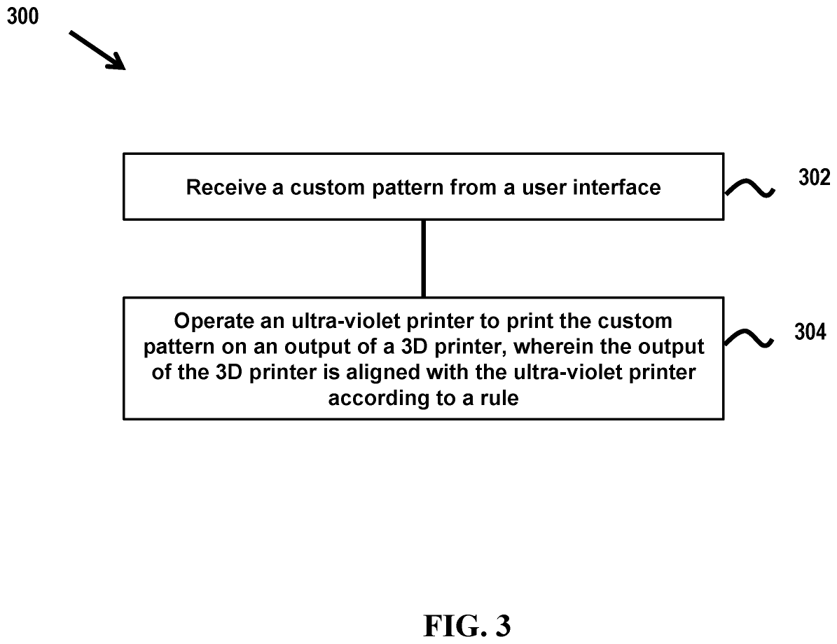

FIG. 3 depicts a flowchart for an example process 300 of operating the customization aspect of 3D printing. At 302, a customization pattern is received from a user interface (UI). The UI may be, for example, UI 114 that is physically located in the kiosk and connected to the printing system 104. In some embodiments, the UI may be that of a user device 112, e.g., a software app running on the user device 112.

At 304, an ultra-violet UV printer is operated to print the customization pattern on the object printed from the 3D printer 106. As described herein, advantageously, the output object is aligned with the ultra-violet printer according to a rule. In some embodiments, instead of a UV printer, another printing mechanism may be used for applying the customization pattern to the object. For example, an embossing machine, an ink printer, a high temperature printer, and the like may be used in various embodiments.

In some embodiments, after a user uploads a custom pattern, a check may be made about available printing resources and whether the user's request can be fulfilled. In some embodiments, the check may be performed by a processor at the printing system 104. For example, an estimate of the amount of 3D ink needed to print the user-instructed object may be made. For example, amount of printer resources to further print the custom pattern on the object may be made. If any of these checks indicates that the user's order cannot be currently fulfilled, a message may be provided to the user about the inability to execute the request. In addition, a suggested future time may be provided to the user. Following such a determination, a service request may be sent to an appropriate entity in the cloud resources 116 to refill the resources needed for future execution of such requests.

In some embodiments, the custom pattern, in conjunction with the printed object, may form a non-fungible token (NFT) that is unique due to the specific custom pattern and the substrate used for printing the 3D object. In some cases, a special indication may be provided to the printing system 104 that the printing job is for an NFT, in which case, the 3D printer and/or the labeler may operate to insert a unique identification such as a sequence number, a time/date/location stamp on the custom object that is manufactured at the end of the process.

### 8. Examples of Cloud-Based Monitoring

The cloud-based computing resources 116 may be used to implement various functions in the system 100. In some embodiments, a setup function may be implemented to enable setting up new kiosks or servicing an existing kiosk. The setup function may be interactively used by an onsite technician to set up the printing system 104 and ensure correct operation of the 3D printing functionality. For example, test objects may be printed and customized and a visual or manual feedback may be provided to the setup function that the kiosk is operating according to the target quality.

The computing resources 116 may implement a maintenance function that performs, on a periodic or as-needed basis, remote monitoring of operational conditions of one or more kiosks. The monitoring may request and/or receive ambient condition information, ink level information, use information (e.g., how often was the printer used), may request performing an alignment calibration test and received results of the test, and so on.

The computing resources 116 may include a custom pattern validation function that checks whether a new printing order received from a user can be fulfilled at a specific kiosk. If it cannot be fulfilled at the specific kiosk, then the computing resources 116 may find out nearby kiosks where the order can be fulfilled and provide the information to the user. The custom template validation function may also check whether the format of the custom pattern matches the capabilities of the printers used. For example, color combination, resolution of a pattern etc. may be checked to ensure that the final custom 3D object will meet the user's request. In some cases, if it is determined that the user's custom pattern cannot be exactly printed, then an image or graphics indicative of how the object resulting from the user's request may look is generated and displayed to user for the user's approval.

The computing resources 116 may include a billing function that handles payment for the printing tasks, including, for example, interfacing to banking or credit card servers. In some cases, the user may be billed on a per-job or flat-fee basis. In some embodiments, user billing may be based on how much time or how much ink is used for a printing job. In such cases, actual monitoring of resources during the printing operation may be performed. Alternatively, resources used for a specific job may be reported after the job is completed and the billing function may generate a bill according to the actual resources used by the printing system 104.

### 9. Examples of Embodiments

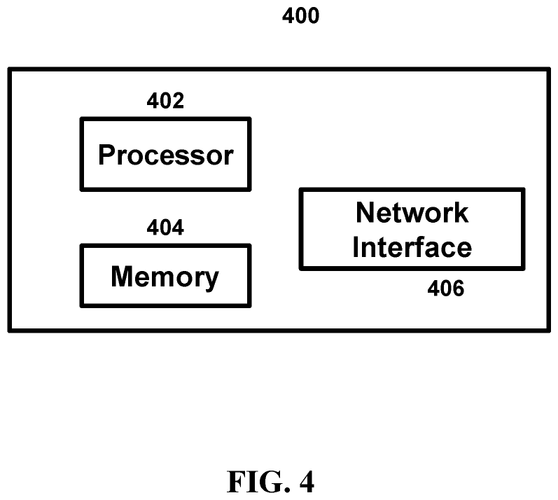

FIG. 4 is a block diagram representation of a wireless hardware platform 400 which may be used to implement the various methods described in the present document. The hardware platform 400 may be incorporated within a base station or a user device. The hardware platform 400 includes a processor 402, a memory 404 (this may be optional and in some cases the memory may be internal to the processor) and a transceiver circuitry 406. The processor may execute instructions, e. g., by reading from the memory 404, and control the operation of the transceiver circuitry 406 and the hardware platform 400 to perform the methods described herein. In some embodiments, the memory 404 and/or the transceiver circuitry 1806 may be partially or completely contained within the processor 402 (e.g., same semiconductor package).

### 10. One Example Workflow

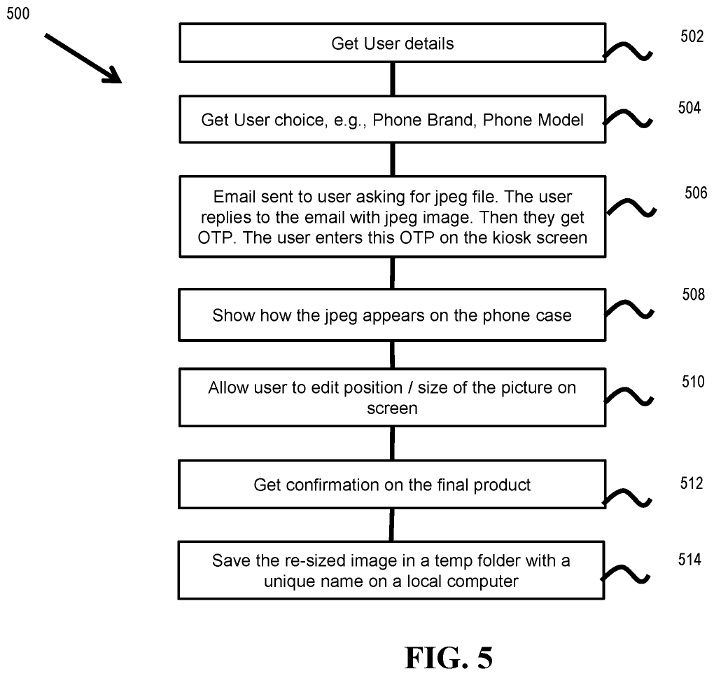

FIG. 5 shows a flowchart of an example method 500 of printing a custom 3D object. At 502, user details are received by the 3D printing system. The user details may include one or more of a user name, a mobile number for contacting the user, the user's email address and so on. These details may be obtained at the kiosk location or remotely from the user's mobile app or computer device. At 504, details about user's desired target object to be printed are obtained. For example, in an example, a user may want to print a phone cover or phone case for a particular phone model. In this example, the user may provide the phone's brand name and model so that the printing system has a precise knowledge of dimensions of the 3d object to be printed, including any openings in the surface of the object to allow it to fit with another object such as a phone. The details of the target object may also be received by the computer system in a suitable image format or another digital file format.

At 506, an email (or a text message) is sent to the user to obtain a custom pattern that the user wants for customization of the 3D object. A reply may be received from the user in which the user attaches the custom pattern in a suitable file format. Upon receiving the information needed to print a 3D object and a custom pattern, the printing system may provide the user with a code such as a one-time password (OTP) that the user will be able to use for an authorized access or printing at the kiosk. Furthermore, at 508, the system may provide a preview to the user of how the custom 3D object will look like after printing, including any warnings or errors about custom pattern format issues, as are described in the present document. For example, commercially available software packages such as Versaworks or Adobe Illustrator may be used for such a depiction.

Upon display of the preview, the user may be allowed to interact with the system to edit the position and/or size of the picture or the custom pattern that would be printed on the 3D object (510). After the user iteratively decides upon the final look of the target object, a confirmation of the final product may be received from the user (512). The re-sized and user-approved custom image is saved in a temporary folder with a unique filename at the computer in the kiosk where the user will be printing the object.

### 11. Examples of Configuring a Printer

In some embodiments, 3D printer settings may be preprogrammed. For example, these settings may allow to vary the print material based on the final printed product requirements. For example, a specific type of ink material (e.g., plastic) may be needed or used to fulfill a particular print job. The 3D printer settings may also be distinguishable based on amount of print time that may be needed to print certain jobs. In other words, depending on a time constraint, if there is any, an appropriate printer setting may be used for completing the print job.

In some embodiments, the printer may be configured to move the 3D printed material to a next stage such as for printing a design on the object according to one of many preprogrammed settings. In some embodiments, multiple custom plates may be used based on a type of object being printed.

As mentioned throughout the present document, one technical challenge in to ensure correct alignment of the 3D printed object to be able to print an image on the object. To help overcome this technical problem, a number of custom setups may be predefined to allow accurate printing of an image on a product. These setups may be generated based on a human operator performing careful alignment and inspection of final products based on a test run.

Another configuration of the printer may comprise integrated software functionality into the system to allow validation and updating of the custom designs remotely, as is disclosed in the present application. For example, a number of predefined and validated STL (standard triangle language) style files may be loaded into the system and selected based on a user request.

The predefined printer settings may include a temperature at which the printer is operated. The temperature may be with respect to the temperature of the nozzles and/or the ink used for printing. Another predefined setting may include a nozzle opening setting. This setting may vary over time such that the nozzle opening may be different depending on the part of a job that is currently being printed. Accordingly, feedback may be provided during printing to allow changing of the nozzle opening. Another configuration setting may control print speed.

Another configuration may be print pattern changes.

In some embodiments, the system may be tuned for an optimal operation of the printers. In some embodiments, the system may have external systems to ensure that the entire system is kept within a constant temperature range. In some embodiments, an air purification system may be configured to operate with the printer to ensure quality of air does not get contaminated due to the operation of the printer. In some embodiments, an automated system may be used to receive and/or recycle the raw material used in the kiosks to ensure that carbon footprint of the system is minimized.

In some embodiments, the various configurations of the system described herein may be possible to be configured using a network connection and/or using cloud-based computing resources.

### 12. One Example Workflow

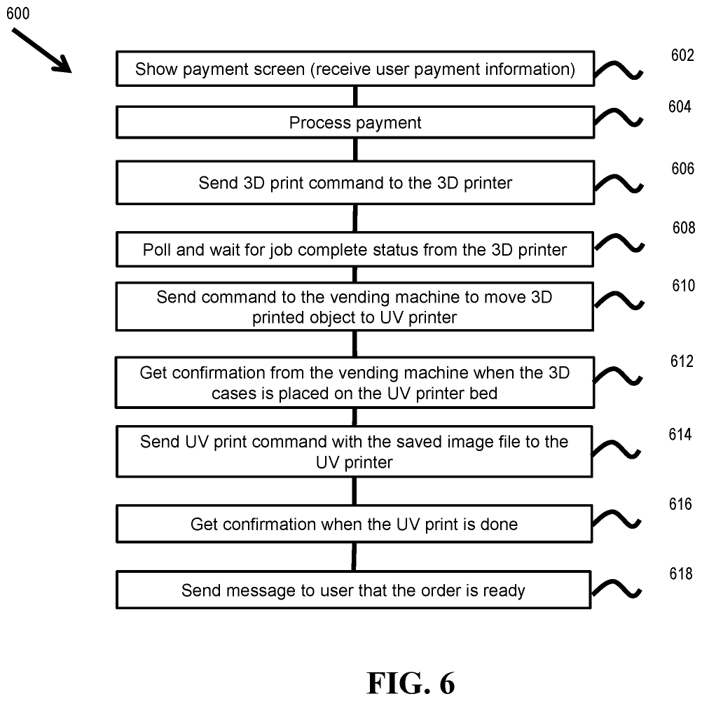

FIG. 6 shows a method 600 for facilitating printing of custom 3D objects. At 602, a user may be shown a payment screen on which the system receives payment information. Upon receiving payment information (e.g., credit card, bank transaction, Venmo or another method of digital cash transaction), the payment may be processed at 604. Next, at 606, an authorization message may be sent to the printer system to print the target 3D object. For example, the message may include an STL file (a type of file format) according to the printer model using a software such as Cura. At 608, the system will poll and wait for a confirmation that the 3D printing of the object was completed successfully. Upon receiving the confirmation, at 610, a command may be sent to the alignment mechanism or the kiosk to move the printed 3D object from the output tray of the 3D printer to the custom printing input tray. The system may wait until receiving a confirmation from the vending machine/alignment mechanism that the placement was completed.

After the system receives a confirmation that the 3D object was successfully placed in the printer bed or input tray of the customization printer (612), the system then sends a command to the customization printer to print the image file (614). After the system receives a confirmation that the custom printing was completed (616), a message is sent to the user that the user's print job is completed and ready for pickup (618).

With present day technologies, sometimes it takes several minutes (e. g. 10 to 20 minutes) to print and customize a 3D object. Therefore, it is likely that a user may not wait at the kiosk for the entire duration. Therefore, in some embodiments, the output tray of the customization printer may be coupled to secure pick-up boxes such that the customized output may be moved to the secure pick-up box or locker that can only be opened using the OTP or another code provided to the user. Furthermore, the printing system may provide a level of parallel processing in which one user may be queuing up his custom printing job, while another user's 3D object may be printing at the same time as a third user's printed object may be undergoing custom printing.

In some embodiments, a user may be able to access kiosk for only the custom printing functionality. In other words, the user may not be interested in printing a 3D object but simply customizing an existing object with an image file imprinted on the object. In such embodiments, a user may be able to access the input tray (bed) of the customization printer using the above-described user identification and payment methods. The input tray may include a visual sign, e.g., a metal bracket or another alignment markers where the user will be asked to place the object she wants to customize. For example, a display screen may play a visual image of how the placement should be performed.

Upon the user providing a confirmation that she has placed the object in the input tray, the system may ingest the input tray and check whether the object has been placed with correct alignment. In some embodiments, this may be achieved by ensuring that the object is touching the marker, e.g., an L-shaped bracket against which a corner of a phone case is snugly placed. In some embodiments, the system may project on a display how the user's customization will look based on the placement of the object. The user may be given opportunity to re-adjust position of the object and/or scale the image to ensure that the customization is to the user's liking. Once the user approves the final look of how the object will look like, the customization printing process (e.g., using labeler 108) may be commenced.

In some embodiments, e. g., when a technician is performing test prints during maintenance, operation 514 may be directly followed by operation 606 in which a print job is started. In other words, the user payment portion 602, 604 may be bypassed.

The following solutions may preferably be used by some embodiments.

A system, e.g., a kiosk, may be configured to implement the following solutions.
1. A method of manufacturing a custom object (e.g., method 200 depicted in FIG. 2 and method 500 depicted in FIG. 5), comprising: generating a three-dimensional (3D) object using a 3D printer (e.g., 202); operating an alignment mechanism to position the object in a customization area (e.g., 204); and generating a target custom object by applying customization to the object in the customization area (e.g., 206).
2. The method of solution 1, wherein the applying the customization includes using a custom pattern obtained from a user to operate an ultra-violet printer.
3. The method of any of solutions 1-2 wherein the alignment mechanism comprises a robotic arm.

Some embodiments that allow for uploading of a custom pattern may use the following solutions.
4. A method of printing a custom object (e.g., method 300 depicted in FIG. 3 and method 600 depicted in FIG. 6), comprising: receiving (302), from a user interface, a custom pattern; and operating (304) an ultra-violet (UV) printer to print the custom pattern on an output of a three-dimensional (3D) printer, wherein the output of the 3D printer is aligned with the UV printer according to a rule.
5. The method of solution 4, wherein the rule is received with the custom pattern.
6. The method of any of solutions 4-5, wherein the output of the 3D printer is aligned using an alignment mechanism.
7. The method of any of solutions 4-6, wherein the UV printer is operated after determining that the custom pattern is printable using the 3D printer and the UV printer.
8. An apparatus for manufacturing a custom object comprising one or more processors and a network interface, wherein the processor is configured to perform a method recited in any of above solutions.
9. A computer-readable medium having code stored thereon; the code, upon execution by a processor, causing the processor to implement a method recited in any of solutions 1-7.
10. A system for fabricating custom 3D objects, comprising: a three-dimensional (3D) printer configured to print a 3D object (e.g., 106); an alignment mechanism (e.g., 110) configured to align the 3D object from an output tray of the 3D printer into an input tray of a labeler (e.g., 108); a labeler configured to print a custom pattern on the 3D object placed in the input tray; and one or more processors configured to control operations of the 3D printer, the alignment mechanism and the labeler.
11. The system of solution 10, wherein the 3D printer, the alignment mechanism and the labeler are at a user-accessible location and the one or more processors are at a different location.
12. The system of any of solutions 10-11, wherein the custom pattern is received from a user interface and wherein the one or more processors provide a preview of an output of the labeler prior to instructing the labeler to print the custom pattern.

Additional embodiment examples of the above-listed solutions are disclosed in sections 1 to 12. It will be appreciated that the present document discloses various techniques for allowing users to fabricate or print custom 3D objects without having to own, maintain or operate a 3D printer. The disclosed embodiments allow users to specify custom designs, preview how their custom object will look like and use a commercially maintained 3D printing facility to receive an accurate, high quality printed 3D object. A person of skill in the art will appreciate that the disclosed techniques may be used to print custom 3D objects such as phone cases, key chains, gift items, beverage holders, pens, and so on and so forth.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, which is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of manufacturing a custom object, comprising:
generating a three-dimensional (3D) object using a 3D printer;
operating an alignment mechanism to position the object in a customization area; and
generating a target custom object by applying customization to the object in the customization area.

2. The method of claim 1, wherein the applying the customization includes using a custom pattern obtained from a user to operate an ultra-violet printer.

3. The method of claim 1, wherein the alignment mechanism comprises a robotic arm.

4. The method of claim 1, wherein the alignment mechanism comprises a tapered chute having a broader opening towards the 3D printer and a narrower opening towards the customization area.

5. The method of claim 4, wherein the operating the alignment mechanism includes exerting mechanical force on the tapered chute to cause the object to be oriented during passing from the 3D printer to the customization area.

6. The method of claim 1, wherein the customization area is positioned vertically lower than the 3D printer allowing the object to pass using gravity.

7. The method of claim 1, wherein the generating the 3D object further includes printing an alignment marker on the 3D object, wherein the alignment marker is configured to provide an orientation cue to the alignment mechanism.

8. The method of claim 1, further including:
transmitting, after the target custom object is generated, a message carrying information about amount of resources used to a server.

9. The method of claim 1, wherein the customization is received as a computer design file or the customization is selected from a library based on an input at a user interface.

10. A computer-readable medium having code stored thereon; the code, upon execution by at least one processor, causing the at least one processor to implement a method comprising:
generating a three-dimensional (3D) object using a 3D printer;
operating an alignment mechanism to position the object in a customization area; and
generating a target custom object by applying customization to the object in the customization area.

11. A system for fabricating custom 3D objects, comprising:
a three-dimensional (3D) printer configured to print a 3D object;
an alignment mechanism configured to align the 3D object from an output tray of the 3D printer into an input tray of a labeler;
a labeler configured to print a custom pattern on the 3D object placed in the input tray; and
one or more processors configured to control operations of the 3D printer, the alignment mechanism and the labeler.

12. The system of claim 11, wherein the 3D printer, the alignment mechanism and the labeler are at a user-accessible location and the one or more processors are at a different location.

13. The system of claim 11, wherein the custom pattern is received from a user interface and wherein the one or more processors provide a preview of an output of the labeler prior to instructing the labeler to print the custom pattern.

14. The system of claim 11, wherein the alignment mechanism comprises a robotic arm.

15. The system of claim 11, wherein the alignment mechanism comprises a tapered chute having a broader opening towards the 3D printer and a narrower opening towards the labeler.

16. The system of claim 15, wherein the alignment mechanism is configured to exert a mechanical force on the tapered chute to cause the 3D object to be oriented during passing from the 3D printer to the labeler.

17. The system of claim 11, wherein the input tray of the labeler is positioned vertically lower than the output tray of the 3D printer allowing the object to pass using gravity.

18. The system of claim 11, wherein the 3D printer is configured to print an alignment marker on the 3D object, wherein the alignment marker is configured to provide an orientation cue to the alignment mechanism.

19. The system of claim 11, wherein the system is configured to transmit, after the custom pattern is printed, a message carrying information about amount of resources used to a server.

20. The system of claim 11, further including a temperature controller that is configured to control a temperature of the 3D printer at a target temperature.
